(19) United States
(12) Patent Application Publication
(10) Pub. No.: US 2005/0041093 A1
(43) Pub. Date: Feb. 24, 2005

(54) Media construction for use in auto-focus laser

(76) Inventors: Gregory L. Zwadlo, Ellsworth, WI (US); Richard R. Ollmann JR., Woodbury, MN (US)

Correspondence Address: Robert Leonard;Faegre & Benson LLP, 2200 Wells Fargo Center, 90 South Seventh Street, Minneapolis, MN, 55402-3901, US

(21) Appl. No.: 10/646,651

(22) Filed: Aug. 22, 2003

(51) Int. Cl. B41J 2/435; B41J 2/47

(52) U.S. Cl. 347/234; 347/248

(57) ABSTRACT

A media transfer sheet includes a light absorbing layer. The light absorbing layer is selected to absorb light at a wavelength that is close to light produced by a focusing light source. The light absorbing layer is placed in the media transfer sheet at a desired focus level for an imaging light source, within the media transfer sheet. The light absorbing layer does not allow any significant portion of the light from the focusing layer to pass therethrough, but does allow for reflectance of some portion of that light by the media transfer sheet. By limiting the level of reflection of focusing light, an improved reflected focusing light signal is produced that is more representative of the depth to be measured.

### TECHNICAL FIELD

The present invention relates to the field of thermal transfer printing and more particularly to a thermal transfer donor with improved reflectance characteristics for auto-focusing of the print head.

### BACKGROUND OF THE INVENTION

In the imaging arts, elements that can be image-wise exposed by means of light radiation are well known. The availability of infrared laser diodes has provided a convenient means of generating images onto a variety of substrates using a laser scanner.

In particular, light based (IR, UV, white) and in particular, laser thermal transfer systems have gained significant attention over the past decade. In a typical laser thermal transfer system, a donor sheet comprising a layer of an infrared absorbing transfer medium is placed in contact with a receptor, and the assembly is exposed to a pattern of infrared (IR) radiation. Absorption of the IR radiation causes a rapid build-up of heat in the exposed areas which in turn causes transfer of the medium from the donor to the receptor to form an image. This transfer can result, for example, from sublimation (or diffusion), ablative transfer, film transfer, or mass transfer.

Sublimation or diffusion transfer systems involve a mechanism wherein a colorant is sublimed (or diffused) to the receptor without co-transfer of the polymer. This process enables the amount of colorant transferred to vary continuously with the input of radiation energy. Examples of this type of process are discussed in JP 51-088016; GB 2,083,726; as well as U.S. Pat. Nos. 5,126,760; 5,053,381; 5,017,547 and 4,541,830.

In an ablative thermal transfer system, the exposed transfer medium is propelled from the donor to a receptor by generation of a gas. Specific polymers are selected which decompose upon exposure to heat to rapidly generate a gas. The build-up of gas under or within the transfer media acts as a propellant to transfer the media to the receptor. Examples of various laser ablative systems may be found in U.S. Pat. Nos. 5,516,622; 5,518,861; 5,326,619; 5,308,737; 5,278,023; 5,256,506; 5,171,650; 5,156,938; 3,962,513; and WO 90/12342.

In a mass-transfer system, the colorant and associated polymer materials transfer in a molten or semi-molten state (melt-stick transfer) to a receptor upon exposure to the radiation source. The thermal transfer media sticks to the receptor surface with greater strength than it adheres to the donor surface resulting in physical transfer of the media in the imaged areas. There is essentially 0% or 100% transfer of colorant depending on whether the applied energy exceeds a certain threshold. Examples of these types of systems may be found in JP 63-319192; JP 69-319192; WO 97/15173; EP 530018; EP 602893; EP 675003; EP 745489; U.S. Pat. Nos. 5,501,937; 5,401,606 and 5,019,549.

Each of these transfer systems relies upon a focused radiation source to produce the desired image on the receptor. In order to accomplish the desired image transfer, the radiation must be focused to a point where the colorant meets the substrate.

The focusing of the radiation can be accomplished through use of an auto-focus system as shown in U.S. Pat. No. 6,137,580 where a second radiation source is used to determine a distance from a focused radiation source to the media. The second light source is directed to the surface of the transfer media. The transfer media is partially reflective and produces a reflected light signal. The reflected light signal is then collected by a position sensitive detector. The intensity and position of the reflected light signal is a function of the distance from the light source to the transfer media. This distance information is then used to provide a signal to the focused radiation source to focus the radiation. However, a problem can arise because in some transfer media, multiple reflections of the light signal may occur thus producing an inaccurate measurement of the distance between the first radiation source and the transfer media.

Referring now to prior art FIG. 1, there shown is a focusing light source 10 providing light to the surface of transfer media 30. The light is reflected back to a detector 20. The light source 10 may be an LED that transmits light at a predetermined wavelength, such as 670 nanometers. The light is detected at a detector 20. The detector, which may be a position detection sensor, produces a signal representative of the distance from the focused radiation source 15 to the media. The focused radiation source has a structure, as is well known in the art, to refocus the focused radiation source as a function of the signal. Transfer media 30 is comprised of substrate 32 and colorant 34. A portion of the colorant, when irradiated by the focused radiation source 15 transfers to the recipient 40 that may be supported during this process by drum 50.

Note that the reflected light signal may have multiple components B, C, D and E. At least a portion of the light reaching the transfer media may penetrate through the substrate, colorant or recipient. This created multiple reflections and therefore multiple reflected light signals which in turn made it difficult to measure the desired dimension.

### SUMMARY OF THE INVENTION

The present invention is a structure and process for reducing extraneous multiple reflections from layers of a media transfer structure so that the distance to an outer surface of the media transfer structure can be accurately determined.

The present invention is a transfer media structure and a method of making the transfer media structure where unwanted multiple reflected light signals are reduced or eliminated through use of a radiation absorbing material. The location of the radiation absorbing material can be anywhere within the media transfer structure that causes the unwanted reflections to be absorbed so they do not contribute to the signal received at 20. The radiation absorbing material is selected so as to absorb the light at the wavelength transmitted by the focus light source so that the light is absorbed and is not reflected at the interfaces between layers of the media transfer structure. While the radiation absorbing material absorbs much of the light, a portion of the light is reflected from the outer surface of substrate 32. A sensor is used to sense the reflected light. The depth to the imaged layer 34 can then be measured as a function of the reflected light signal.

### BRIEF DESCRIPTION OF THE DRAWINGS

FIG. 1 is a diagram of a prior art transfer media structure and a light source and sensor for an auto-focusing system.

FIG. 2 is a side view of a first transfer media structure according to the present invention.

FIG. 3 is a side view of a second transfer media structure according to the present invention.

### DETAILED DESCRIPTION OF THE INVENTION

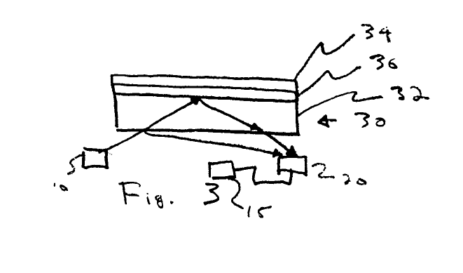

Referring now to FIG. 2, thereshown is a media transfer structure or donor 30 according to the present invention. The donor is comprised of substrate 32, a colorant layer 34 and light absorbing layer 36.

A focusing light source 10 provides light to the surface of transfer media 30. In this case there is always a small amount of reflected light from the outer surface of layer 36 in FIG. 2. This is the useful signal. Light from the focus laser that would otherwise go through layer 30 and be reflected at the bottom (inside) surface of 30 is now absorbed so that it does not contribute to focus light received at detector 20. The light source 10 may be an LED that transmits light at a predetermined wavelength, such as 670 nanometers. The light is detected at a detector 20. The detector, which may be a position detection sensor, produces a signal representative of the distance from the focused radiation source 15 to the media. The focused radiation source has a structure, as is well known in the art, to refocus the focused radiation source as a function of the signal.

The donor 30 of the present invention typically includes a substrate on which is coated transfer material, which can be in one or more layers, preferably in one layer, containing a hydroxylic polymer, a fluorocarbon additive, a bleachable infrared absorbing dye, a latent crosslinking agent (i.e., latent curing agent), and a dispersible material (e.g., pigment), all of which are described in detail below. Other components that are optional, although preferred, include a dispersant, and coating aids, such as a fluorocarbon surfactant.

Substrate

Suitable substrates for the donor include, for example, plastic sheets and films, such as, polyethylene terephthalate, fluorene polyester polymers, polyethylene, polypropylene, acrylics, polyvinyl chloride and copolymers thereof, and hydrolyzed and non-hydrolyzed cellulose acetate. The substrate needs to be sufficiently transparent to the imaging radiation emitted by the laser or laser diode to effect thermal transfer of the corresponding image to a receptor sheet. A preferred substrate for the donor is a polyethylene terephthalate sheet. Typically, the polyethylene terephthalate sheet is about 20 μm to about 200 μm thick. If necessary, the substrate may be surface-treated so as to modify its wettability and adhesion to subsequently applied coatings. Such surface treatments include corona discharge treatment, and the application of subbing layers or release layers.

The donor element may include a microstructured surface on the laser addressed surface (i.e., backside) to reduce the formation of optical interference patterns. The microstructured surface may be composed of a plurality of randomly positioned discrete protuberances of varying heights and shapes. Microstructured surfaces may be prepared by the methods described in U.S. Pat. No. 4,340,276 (Maffitt), U.S. Pat. No. 4,190,321 (Dorer), and U.S. Pat. No. 4,252,843 (Dorer).

Binder

The binder in the transfer material comprises a crosslinkable binder which is a hydroxylic polymer (i.e., a polymer having a plurality of hydroxy groups). Preferably, 100% of the polymer is a hydroxylic polymer. Prior to laser address, the transfer material ideally should be in the form of a smooth, tack-free coating, with sufficient cohesive strength and durability to resist damage by abrasion, peeling, flaking, dusting, etc., in the course of normal handling and storage. If the hydroxy-functional polymer is the sole or major component of the polymer, then its physical and chemical properties should be compatible with the above requirements. Thus, film-forming polymers with glass transition temperatures higher than ambient temperature are preferred. The hydroxylicpolymers should be capable of dissolving or dispersing the other components of the transfer material, and should themselves be soluble in the typical coating solvents such as lower alcohols, ketones, ethers, hydrocarbons, haloalkanes and the like.

The hydroxy groups may be alcoholic groups or phenolic groups (or both), but alcoholic groups are preferred. The requisite hydroxy groups may be incorporated by polymerization or copolymerization of hydroxy-functional monomers such as allyl alcohol and hydroxyalkyl acrylates or methacrylates, or by chemical conversion of preformed polymers, e.g., by hydrolysis of polymers and copolymers of vinyl esters such as vinyl acetate. Polymers with a high degree of hydroxy functionality, such as poly(vinyl alcohol), cellulose, etc., are in principle suitable for use in the invention, but in practice their solubility and other physico-chemical properties are less than ideal for most applications. Derivatives of such polymers, obtained by esterification, etherification, or acetalization of the bulk of the hydroxy groups, generally exhibit superior solubility and film-forming properties, and provided that at least a minor proportion of the hydroxy groups remain unreacted, they are suitable for use in the invention. Indeed, the preferred hydroxylic polymer for use in the invention belongs to this class, and is the product formed by reacting poly(vinyl alcohol) with butyraldehyde. Commercial grades of this material typically leave at least 5% of the hydroxy groups unreacted (i.e., free) and combine solubility in common organic solvents with excellent film-forming and pigment-dispersing properties.

Preferably, the hydroxylic polymer is a polyvinyl butyral polymer available under the trade designation BUTVAR B-76 from Monsanto, St. Louis, Mo. This particular polymer has a softening range of about 140° C. to about 200° C. Other hydroxylic polymers from the BUTVAR series of polymers may be used in place of the BUTVAR B-76. These include, for example, other polyvinyl butyral polymers available under the trade designations BUTVAR B-79 from Monsanto and MOWITAL B30T from Hoechst Celanese, Chatham, N.J. The various products typically vary with respect to the amount of free hydroxyl groups. For example BUTVAR B-76 polyvinyl butyral includes less than about 15-mole % free hydroxy groups, whereas MOWITAL B30T polyvinyl butyral includes about 30% free hydoxy groups. Although such polyvinyl butyral polymers are not typically used in crosslinking reactions, in the system of the present invention it is believed that the BUTVAR B-76 polyvinyl butyral crosslinks with the latent crosslinking agent described below.

Alternatively, a blend of one or more noncrosslinkable polymers with one or more crosslinkable hydroxy-functional polymers may be used. The noncrosslinkable polymer typically provides the requisite film-forming properties, which may enable the use of lower molecular weight polyols, but this is not preferred. Such polymers should be compatible with the laser-address system of the present invention such that they do not interfere with the color formation. That is, they should be nonreactive when exposed to the conditions used during imaging of the laser-address system of the present invention. Suitable such polymers include, for example, polyesters, polyamides, polycarbamates, polyolefins, polystyrenes, polyethers, polyvinyl ethers, polyvinyl esters, polyacrylates, polymethacrylates, and the like. Some examples of suitable noncrosslinkable polymers that can be combined with the crosslinkable polymer described above in the transfer material include, for example, polymethyl methacrylate polymers, such as that available under the trade designation ELVACITE from DuPont, Wilmington, Del. Whether crosslinkable or noncrosslinkable, polymers that decompose under laser address imaging conditions are less desirable, although not entirely unusable. For example, polymers and copolymers of vinyl chloride are less desirable because they can decompose to release chlorine, which leads to discoloration and problems with accurate color match.

The hydroxylic polymer is present in an amount of about 25 wt-% to about 75 wt-%, preferably in an amount of about 35 wt-% to about 65 wt-%, based on the dry coating weight of the transfer material. Preferably, the hydroxy-equivalent weight of the total polymer is at least about 1000 grams/mole.

Fluorocarbon Additive

The transfer material also includes a fluorocarbon additive for enhancing transfer of a molten or softened film and production of half tone dots (i.e., pixels) having well-defined, generally continuous, and relatively sharp edges. Under the conditions currently used in preparing and imaging the system of the present invention, it is believed that the fluorocarbon additive serves to reduce the cohesive forces within the transfer material at the interface between the laser-exposed heated regions and the unexposed regions, and thereby promotes clean “shearing” of the layer in the direction perpendicular to its major surface. This provides improved integrity of the dots with sharper edges, as there is less tendency for “tearing” or other distortion as the transferred pixels separate from the rest of the donor layer. Thus, unlike dye transfer systems, in which just the colorant is transferred, and unlike ablation transfer systems, in which gases are typically formed that propel the colorant toward the receptor, the system of the present invention forms images by transfer of the polymer, pigment, and other additives, in a molten or softened state as a result of a change in cohesive forces. The change in cohesive forces assists in limiting the domain of the transferred material, thus, providing more control of the dot size.

A wide variety of compounds may be used, as the fluorocarbon additive, provided they are substantially involatile under normal coating and drying conditions, and sufficiently miscible with the polymer material(s). Thus, highly insoluble fluorocarbon polymers, such as polytetrafluoroethylene and polyvinylidenefluoride, are unsuitable, as are gases and low boiling liquids, such as perfluoralkanes. With the above exceptions, both polymeric and lower molecular weight materials may be used, although the latter are preferred. Preferably the fluorocarbon additive is selected from compounds comprising a fluoroaliphatic group attached to a polar group or moiety and fluoropolymers having a molecular weight of at least about 750 and comprising a non-fluorinated polymeric backbone having a plurality of pendant fluoroaliphatic groups, which aliphatic groups comprise the higher of: (a) a minimum of three C—F bonds; or (b) in which 25% of the C—H bonds have been replaced by C—F bonds such that the fluorochemical comprises at least 15% by weight of fluorine.

Suitable fluorocarbon additives are disclosed in EP Publication No. 0 602,893 (3M) and the references cited therein. A preferred fluorocarbon additive is a sulfonamido compound (C₈F₁₇)SO₂ NH(CH₂CH₃) (N-ethyl perfluorooctanesulfonamide), which includes 70% straight chains and 30% branched chains. The fluorocarbon additive is typically used in an amount of about 1 weight percent to about 10 weight percent, based on the dry coating weight of the transfer material. Preferably, the weight ratio of fluorocarbon to dispersible material (e.g., pigment) is at least about 1:10, and more preferably at least about 1:5.

Infrared Absorbing Dye

The infrared absorbing dye (also referred to as a “photothermal converting dye”) used in the system of the present invention is a light-to-heat converter. It is a cationic dye. Cationic dyes produce transparent films when in combination with the polymer polymer and other components of the transfer material described herein. In contrast, neutral dyes, such as squarylium and croconium dyes, produce dispersion aggregates resulting in coatings with visible agglomerated pigments. Also, anionic dyes, such as cyanine dyes, are incompatible with the transfer material of the present invention, and result in flocculation of the pigment dispersion.

The infrared absorbing dye is preferably a bleachable dye, meaning that it is a dye capable of being bleached. Bleaching of the dye means that there is an effective dimunition in intensity of absorption bands that give rise to visible coloration of the infrared absorbing dye. Bleaching of the infrared absorbing dye may be achieved by destruction of its visible absorption bands, or by shifting them to wavelengths that do not give rise to visible coloration, for example. Bleaching can occur, for example, in the receiver when it is heated by a laminating step. Suitable cationic dyes for use in the transfer material of the present invention may be selected from the group consisting of tetraarylpolymethine (TAPM) dyes, amine cation radical dyes, and mixtures thereof. Preferably, the dyes are the tetraarylpolymethine (TAPM) dyes. Dyes of these classes are typically found to be stable when formulated with the other ingredients (i.e., to be compatible with the polymer polymer and other components of the transfer material), and to absorb in the correct wavelength ranges for use with the commonly available laser sources. Furthermore, dyes of these classes are believed to react with the latent crosslinking agent, described below, when photoexcited by laser radiation. This reaction not only contributes to bleaching of the infrared absorbing dye, but also leads to crosslinking of the polymer, as described in greater detail below.

Yet another useful property shown by many of these dyes is the ability to undergo thermal bleaching by nucleophilic compounds and reducing agents that may be incorporated in the receptor layer, as is also described in greater detail below.

TAPM dyes comprise a polymethine chain having an odd number of carbon atoms (5 or more), each terminal carbon atom of the chain being linked to two aryl substituents. These generally absorb in the 700 nm to 900 nm region, making them suitable for diode laser address. There are several references in the literature to their use as absorbers in laser address thermal transfer media, e.g., JP Publication Nos. 63-319191 (Showa Denko) and 63-319192 (Shonia Denko), U.S. Pat. No. 4,950,639 (DeBoer), and EP Publication Nos. 0 602 893 (3M Company) and 0 675 003 (3M Company). When these dyes are cotransferred with pigment, a blue cast is given to the transferred image because the TAPM dyes generally have absorption peaks which tail into the red region of the spectrum. However, this problem is solved by means of the bleaching processes, and described in greater detail below.

Preferred dyes of the TAPM class have a nucleus of formula (I): 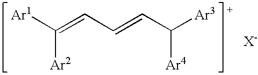
wherein: Ar¹ to Ar⁴ is aryl groups that are the same or different and at least one (and more preferably at least two) of the aryl groups represented by Ar¹ to Ar⁴ has a cationic amino substituent (preferably in the 4-position), and X is an anion. Preferably no more than three (and more preferably no more than two) of said aryl groups bear a cationic amino group. The aryl groups bearing said cationic amino groups are preferably attached to different ends of the polymethine chain (i.e., Ar¹ or Ar² and Ar³ or Ar⁴ have cationic amino groups).

Examples of cationic amino groups include dialkylamino groups (such as dimethylamino, diethylamino, etc.), diarylamino groups (such as diphenylamino), alkylarylamino groups (such as N-methylanilino), and heterocyclic groups such as pyrrolidino, morpholino, or piperidino. The cationic amino group may form part of a fused ring system.

The aryl groups represented by Ar¹ to Ar⁴ may comprise substituted or unsubstituted phenyl, naphthyl, or other fused ring systems, but phenyl rings are preferred. In addition to the cationic amino groups discussed previously, substituents which may be present on the rings include alkyl groups (preferably of up to 10 carbon atoms), halogen atoms (such as Cl, Br, etc.), hydroxy groups, thioether groups and alkoxy groups. Substituents which donate electron density to the conjugated system, such as alkoxy groups, are particularly preferred. Substituents, especially alkyl groups of up to 10 carbon atoms or aryl groups of up to 10 ring atoms, may also be present on the polymethine chain.

Preferably the anion X is derived from a strong acid (e.g. HX should have a pKa of less than 3, preferably less than 1). Suitable identities for X include ClO₄, BF₄, CF₃ SO₃, PF₆, AsF₆, SbF₆ and perfluoroethylcyclohexylsulphonate.

Particularly preferred cationic polymethine dyes that can be bleached by reacting with various bleaching agents have the following structures:

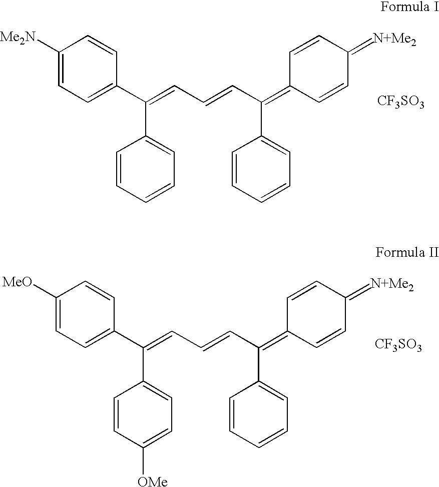

The TAPM dyes of formula (I) may be synthesized by known methods, e.g., by conversion of the appropriate benzophenones to the corresponding 1,1-diarylethylenes (by the Wittig reaction, for example), followed by reaction with a trialkyl orthoester in the presence of strong acid HX.

Suitable cationic infrared dyes, although less preferred than the TAPM dyes as the TAPM dyes are more readily bleached, include the class of amine cation radical dyes (also known as immonium dyes) disclosed, for example, in International Publication No. WO 90/12342, JP Publication No. 51-88016 (Canon) and (in greater detail) in European Patent No. Application No. 96/302794.1 (3M). Included in this class are the diamine dication radical dyes (in which the chromophore bears a double positive charge), exemplified by materials such as CYASORB IR165, which is commercially available from Glendale Protective Technologies Inc., Lakeland, Fla. Such dyes have a nucleus of the following general formula (II): 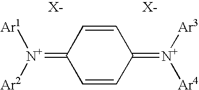
in which Ar¹—Ar⁴ and X are as defined above. Dyes of this class typically absorb over a broad range of wavelengths in the near infrared, making them suitable for address by YAG lasers as well as diode lasers. Although these dyes show peak absorptions at relatively long wavelengths (approximately 1050 nm, suitable for YAG laser address), the absorption band is broad and tails into the red region, which gives a blue cast to the transferred image. As discussed above, this problem is solved by means of a bleaching process described in greater detail below.

The bleachable infrared absorbing dye is preferably present in a sufficient quantity to provide a transmission optical density of at least about 0.5, more preferably, at least about 0.75, and most preferably, at least about 1.0, at the exposing wavelength.

Typically, this is accomplished with about 3 wt-% to about 20 wt-% infrared dye, based on the dry coating weight of the transfer material.

Latent Crosslinking Agent

The latent crosslinking agent (i.e., latent curing agent) is a compound having a moiety of formula (III): 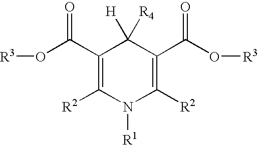
wherein: R¹ is Hydrogen or an organic group, and each of R² and R³ is an organic group, and R⁴ aryl. Each of R¹, R², and R³ can be a polymeric group. That is, these can be compounds of formula (III) form polymers, as long as the carbonyl groups are available for interaction with the hydroxylic polymer. Preferably, R¹ is selected from the group of H, an alkyl group, a cycloalkyl group, and an aryl group (more preferably, R¹ is selected from the group of an alkyl group, a cycloalkyl group, and an aryl group); each R² and R³ is independently an alkyl group or an aryl group; and R⁴ is an aryl group.

This latent crosslinking agent is preferably used in the transfer material in an amount of up to about 30 wt-%, based on the dry coating weight of the transfer material, although it can be used in the receptor element in addition to being used in the donor element. As used herein, a latent crosslinking agent is typically only reactive in the system under conditions of laser address.

The crosslinking agent is believed to be important for providing cohesion within the transferred pixel. This complements the action of the fluorocarbon additive, and results in transfer of the pixel as a coherent film, which enables dots of controlled size with sharp edges to be formed, leading to high quality images with reproducible colors.

The crosslinking effect during laser imaging results in a high quality transferred dot formed of a film with well-defined, generally continuous, and relatively sharp edges. It also prevents retransfer of colorant back to the donor, as well as back transfer of colorant to the donor in a subsequent imaging step. This greatly simplifies the imaging process, as well as yielding more controllable film transfer. These effects can be enhanced by subsequent heating to promote higher crosslink density.

In formula (III), R¹ preferably is any group compatible with formation of a stable pyridinium cation, which includes essentially any alkyl, cycloalkyl or aryl group, but for reasons of cost and convenience, lower alkyl groups having 1 to 5 carbon atoms (such as methyl, ethyl, propyl, etc.) or simple aryl groups (such as phenyl, tolyl, etc.) are preferred. Similarly, R² may represent essentially any alkyl or aryl group, but lower alkyl groups of 1 to 5 carbon atoms (such as methyl, ethyl, etc.) are preferred for reasons of cost and ease of synthesis. R³ may also represent any alkyl or aryl group, but is preferably selected so that the corresponding alcohol or phenol, R³—OH, is a good leaving group, as this promotes the transesterification reaction believed to be central to the curing mechanism. Thus, aryl groups comprising one or more electron-attracting substituents such as nitro, cyano, or fluorinated substituents, or alkyl groups of up to 10 carbon atoms are preferred. Most preferably, each R³ represents lower alkyl group such as methyl, ethyl, propyl etc, such that R³—OH is volatile at temperatures of about 100° C. and above. R⁴ may represent any aryl group such as phenyl, naphthyl, etc., including substituted derivatives thereof, but is most conveniently phenyl.

Analogous compounds in which R⁴ represents H or an alkyl group are not suitable for use in the donor elements of the invention, because such compounds react at ambient or moderately elevated temperatures with many of the infrared dyes suitable for use in the invention, and hence the relevant compositions have a limited shelf life. In contrast, the compounds in which R⁴ is an aryl group are stable towards the relevant dyes in their ground state, and the relevant compositions have a good shelf life. The analogous compounds in which R⁴ represents H or an alkyl group may, however, be incorporated in the receptor, where their thermal bleaching action towards the infrared absorbing dye is beneficial.

Significantly, because the latent crosslinking agent can also act as a bleaching agent, it helps control the heat generated during imaging. That is, the latent crosslinking agent helps bleach the infrared absorbing dye, thereby quenching the dye's absorption and moderating any tendency for runaway temperature rises, which could possibly cause ablation of the coating.

Such dihydropyridines can be prepared by known methods, e.g., by an adaptation of the Hantzsch pyridine synthesis. A particularly preferred latent crosslinking agent used in the transfer material is an N-phenyldihydropyridine-derived compound. It has the following structure: 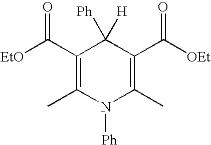
Dispersible Material

The dispersible material (also referred to as the “dispersed” material when dispersed within the transfer material) is a particulate material that is of sufficiently small particle size that it can be dispersed within the transfer material, with or without the aid of a dispersant. Suitable dispersible materials for use in the transfer material typically include colorants such as pigments and crystalline nonsublimable dyes. The pigment(s) or nonsublimable dye(s) in the transfer material are those typically used in the printing industry. Thus, the dispersible materials may be of a variety of hues. Alternatively, they may not necessarily add color but simply enhance the color (i.e., color enhancing additives), or they may be clear or colorless and provide a texturized image (i.e., texturizing material). Thus, the transfer material used in forming a color proof may also be colorless when it is desirable to stimulate a spot varnish, for example. Such texturizing materials can be colorless when their index of refraction matches that of the polymer.

Essentially any dye or pigment or mixture of dyes and/or pigments of the desired hue may be used as a dispersible material in the transfer material. They are generally insoluble in the transfer material coating composition and are nonsublimable under imaging conditions at atmospheric pressures. They should also be substantially unreactive with the bleaching agent under both ambient conditions and during the imaging process.

Dispersible materials that enhance color (i.e., color enhancing additives) include, for example, fluorescent, pearlescent, iridescent, and metallic materials. Materials such as silica, polymeric beads, reflective and non-reflective glass beads, or mica may also be used as the dispersible material to provide a textured image. Such materials are typically colorless, although they may be white or have a color that does not detract from the color of the pigment, for example, and can be referred to as texturizing materials. The color enhancing additives or texturing materials may be used either alone or in combination with pigments or crystalline nonsublimable dyes to produce proofs with the desired visual effects.

Pigments and crystalline nonsublimable polymeric dyes are preferred because they have a lower tendency for migration between the layers. Pigments are more preferred due to the wide variety of colors available, their lower cost, and their greater correlation to printing inks. Pigments in the form of dispersions of solid particles are particularly preferred. Solid-particle pigments typically have a much greater resistance to bleaching or fading on prolonged exposure to sunlight, heat, humidity, etc., in comparison to soluble dyes, and hence can be used to form durable images. The use of pigment dispersions in color proofing materials is well known in the art, and any of the pigments previously used for that purpose may be used in the present invention. Pigments or blends of pigments matching the yellow, magenta, cyan, and black references provided by the International Prepress Proofing Association (known as the SWOP color references) are particularly preferred, although the invention is by no means limited to these colors. Pigments of essentially any color may be used, including those conferring special effects such as opalescence, fluorescence, UV absorption, IR absorption, ferromagnetism, etc.

Transfer media intended for color imaging preferably contain sufficient dispersible material to preferably provide a reflection optical density of at least 0.5, preferably preferably, at least 1.0, at the relevant viewing wavelength(s). Thus, the pigment(s) or nonsublimable dye(s) are preferably present in the transfer material in an amount of about 10 weight percent (wt-%) to about 40 weight percent, based on the dry weight of the transfer material.

Pigments are generally introduced into the transfer material composition in the form of a millbase comprising the pigment dispersed with a polymer and suspended in a solvent or mixture of solvents. The dispersion process may be accomplished by a variety of methods well known in the art, such as two-roll milling, three-roll milling, sand milling, ball milling, etc. Many different pigments are available and are well known in the art. The pigment type and color are chosen such that the coated color proofing element is matched to a preset color target or specification set by the industry.

The type and amount of polymer used in the dispersion are dependent upon the pigment type, surface treatment on the pigment, dispersing solvent, and milling process. The polymer is typically the same hydroxy-functional polymer described above. A preferred polymer is a polyvinyl acetal such as a polyvinyl butyral available under the trade designation BUTVAR B-76 from Monsanto, St. Louis, Mo.

Focus Light Absorbing Layer

The light absorbing layer generally can is made from materials that absorb light in the spectrum where the focus laser emits light and are transparent to the imaging radiation. Examples of such materials for the chosen focusing and imaging lights are shown below. However, any other material fitting the above criteria may qualify as a light absorbing layer in the circumstance.

In a first composition, 0.75 grams of Heptyl Cyan (1,4-Bis(1-methylhexylamino)-5,8-dihydroxyanthraquine) is added to 80 grams of a solution of 7.5% Butvar B-76 in MEK. This solution was coated with a Myer wire wrapped coating rod onto Dupont 563 PET film and dried. The other side was coated with standard yellow Matchprint Digital Halftone Formulation and imaged. The film absorbance with a measurement light at 670 nanometers was as follows:

| bar# | Abs @670 nm |
|---|---|
| 11 | 0.50 |
| 18 | 0.77 |
| 24 | 0.98 |

The bar # represents the wire diameter that leads to a particular wet film thickness.

For example, an 11 represents the wire diameter in mils of an inch which produces about 18 micron wet film thickness, 18 wire diameter is 28 microns thickness and 24 wire diameter produces 41 microns thickness.

As an alternative option, the backside of a yellow MatchPrint Digital Halftone (“MPDH”) available from Kodak Polychrome Graphics donor was coated with Reflux Blue colorant used in the commercially available Matchprint Plus from Kodak Polychrome Graphics system using the MP Plus coating table as specified in the directions. Similar results to the first composition noted above were achieved. (These examples are represented in FIG. 2)

A third presently preferred embodiment is the bleachable dye shown below: 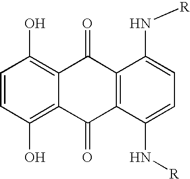
1,4-diamino-5,8-dihydroxyantraquinone derivatives 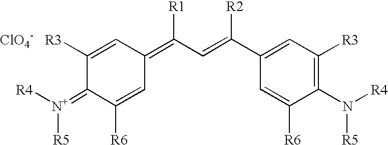
R×s=H: dimethyl {4-[3-(4-dimethylaminophenyl)-2-propenylidene]12,5-cyclohexadien-1-ylidene}ammonium perchlorate

The mixture is made in the ratio of 0.198 grams dye to 30 grams solution. When this formulation was imaged and laminated to base, the 670 dye was found to completely bleach so that the yellow color was correct. Correct in this context means that it matches the color obtained with current MPDH system without the dye included.

Improved focusing was observed.

Other useful dyes (note that these are not bleachable dyes, but simply focus light absorbing dyes that would be useful in layer 36 of FIG. 2) include Wright Stain solution in methanol; Azure B; 1,1′-Diethyl-4,4′-carbocyanine iodide; Giemsa Stain; α-Naphtholphthalein; Hydroxy Naphthol Blue, disodiium salt; Jenner Stain; Solvent Blue 35; Basic Blue 3; Azure II; Methylene Green, zinc chloride double salt; Nickel phthalocyaninetetrasulfonic acid, tetrasodium salt; Janus Green B; Methylene Blue; Acid Black 48; Methylene Blue, zinc chloride double salt monohydrate; Luxol Fast Blue MBSN; Cupromeronic Blue; Acid Green 41; Copper phthalocyaninetetrasulfonic acid, tetrasodium salt; Prussian Blue; 1,1′-Diethyl-4,4′-carbocyanine iodide; Haphthol Green B; Idocyanine Green; Copper phthalocyanine

Optional Additives

Coating aids, dispersing agents, optical brighteners, UV absorbers, fillers, etc., can also be incorporated into the pigment mill base, or in the overall transfer material composition. Dispersing agents (i.e., dispersants) may be necessary to achieve optimum dispersion quality. Some examples of dispersing agents include, for example, polyester/polyamine copolymers, alkylarylpolyether alcohols, acrylic polymers, and wetting agents. The preferred dispersant in the transfer material is a block copolymer with pigment affined groups, which is available under the trade designation DISPERBYK 161 from Byk-Chemie USA, Wallingford, Conn. The dispersing agent is preferably used in the dispersion in an amount of about 1 weight percent to about 6 weight percent, based on the dry coating weight of the transfer material.

Surfactants may be used to improve solution stability. A wide variety of surfactants can be used. One preferred surfactant is a fluorocarbon surfactant is used in the transfer material to improve coating quality. Suitable fluorocarbon surfactants include fluorinated polymers, such as the fluorinated polymers described in U.S. Pat. No. 5,380,644 (Yonkoski et al.). It is used in an amount of at least about 0.05 weight percent, preferably at least about 0.05 weight percent and no greater than about 5 weight percent, and typically in an amount of no greater than about 1-2 weight percent.

Preparation of the Donor Element

The transfer material may be coated as a single layer, or as two or more contiguous layers. For example, the infrared dye may be coated as an underlayer with the remaining ingredients coated on top, but a transfer medium comprising all the necessary components in a single layer is preferred.

The relative proportions of the components of the transfer material may vary widely, depending on the particular choice of ingredients and the type of imaging required. For example, transfer materials designed for color proofing purposes typically have a high pigment to polymer ratio, and may not require a high degree of curing in the transferred image.

Transfer material compositions for use in the invention are readily prepared by dissolving or dispersing the various components in a suitable solvent, typically an organic solvent, and coating the mixture on a substrate. The solvent is typically present in an amount of at least about 80 weight percent. The organic solvent is typically an alcohol, a ketone, an ether, a hydrocarbon, a haloalkane, or mixtures thereof. Suitable solvents include, for example, methanol, ethanol, propanol, 1-methoxy ethanol, 1-methoxy-2-propanol, methyl ethyl ketone, diethylene glycol monobutyl ether (butyl CARBITOL), and the like. Typically, a mixture of solvents is used, which assists in controlling the drying rate and avoiding forming cloudy films. An example of such a mixture is methyl ethyl ketone, ethanol, and 1-methoxy propanol.

Pigmented transfer material compositions are most conveniently prepared by predispersing the pigment in the hydroxy polymer in roughly equal proportions by weight, in accordance with standard procedures used in the color proofing industry, thereby providing pigment “chips.” Milling the chips with solvent provides a millbase, to which further polymer, solvents, etc., are added as required to give the final coating formulation. Any of the standard coating methods may be employed, such as roller coating, knife coating, gravure coating, bar coating, etc., followed by drying at moderately elevated temperatures.

The relative proportions of the components of the transfer material may vary widely, depending on the particular choice of ingredients and the type of imaging required.

Preferred pigmented media for use in the invention have the following approximate composition (in which all percentages are by weight):

| | |
|---|---|
| hydroxylic-polymer | 35 to 65% |
| (e.g., BUTVAR B76) | |
| latent curing agent | up to 30% |
| infrared dye | 3 to 20% |
| pigment | 10 to 40% |
| pigment dispersant | 1 to 6% |
| (e.g., DISPERBYK 161) | |
| fluorochemical additive (e.g. | 1 to 10% |
| a perfluoroalkylsulphonamide) | |

Thin coatings (e.g., of less than about 3 μm dry thickness) of the transfer material composition may be transferred to a variety of receptor sheets by laser irradiation. Transfer occurs with high sensitivity and resolution, and heating the transferred image for relatively short periods (e.g., one minute or more) at temperatures in excess of about 120° C. causes curing and hardening, and hence an image of enhanced durability. Although primarily designed for transfer to paper or similar receptors for color proofing purposes, transfer material compositions described herein may alternatively be transferred to a wide variety of substrates.

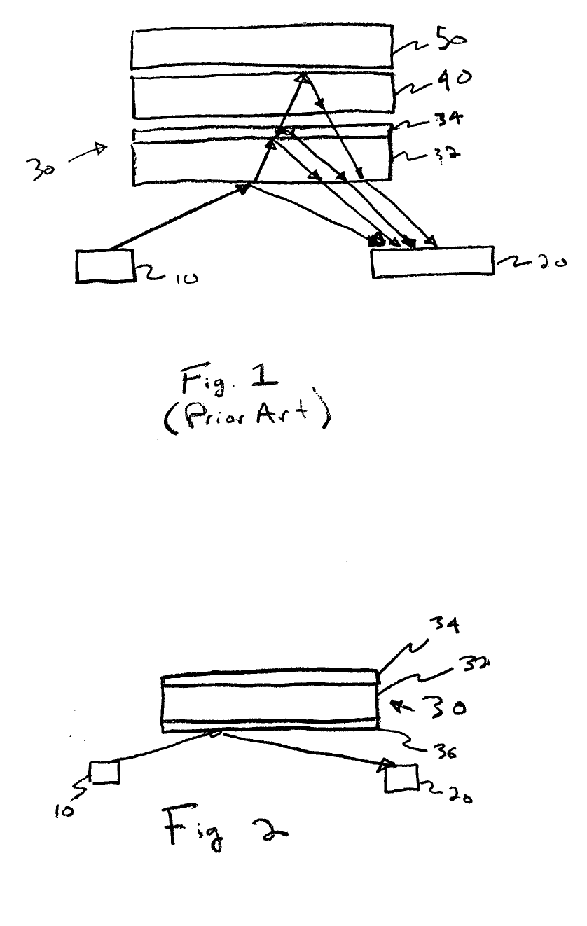

In FIG. 3, a second structure according to the present invention is shown. Here, the light absorbing layer is positioned between the substrate 32 and the colorant layer 34. This layer absorbs most of the light penentrating beyond the closest surface of substrate 32 such that reflected light C₁ and C₂ from the substrate-colorant interface (interface between 32 and 34) is attenuated significantly over the reflected light C in FIG. 1 such that the signal B in FIG. 3 is of much larger magnitude at the focus light detector 20 than is signal C₁. It reduces these unwanted reflections and makes the outer surface signal the dominant one that the focus light detector responds to.

These examples show that the focus light absorbing layer can be on either side of the donor element or even within it. The donor element substrate could also include this absorbing layer within it as for example in a laminated construction or as a coloring of the substrate as in, for example X-ray films.

The intent of the present invention is to minimize some reflected signals with respect to primary outer surface reflected signal so that the return light signal is representative of the distance to a selected depth in the donor. In one embodiment of the present invention, a Creo Trendsetter 3244 autofocus mechanism is used for producing the light signal and detecting the return signal. The Creo Trendsetter 3244 is available from Creo Ltd., 3700 Gilmore Way, Burnaby, BC V5G 4M1 Canada.

Further, the focusing light source is preferably at least 100 nm below the wavelengths of the imaging light. For example, in one presently preferred embodiment, the ranging light source is centered at 670 nm while the imaging light sources are in the range of 800-840 nm.

The foregoing has been a description of a novel and non-obvious media for printing. The applicants have provided this description as an explanation of their invention, not as limitations. The inventors define their invention through the claims attached hereto.

We claim:

1. A media, comprising:
a substrate;
a colorant on the substrate; and
a focus light absorbing material on the substrate.

2. The media of claim 1, wherein the substrate has a first and second surface, the colorant covers at least part of the first surface and the light absorbing material covers at least a portion of the second surface.

3. The media of claim 1, wherein the substrate has a first surface covered at least in part by the light absorbing material, the light absorbing material being covered at least in part by the colorant.

4. In a color transfer media formed from a substrate having a first surface, a colorant covering at least part of the first surface, the colorant being adapted to transfer to a receiving object after being radiated with a first source of radiation having a predetermined wavelength, the source of radiation being a selectable distance from the colorant wherein the selected distance is determined by radiating the media by a second source of radiation at a predetermined wavelength and sensing reflected radiation, an improvement comprising:
a radiation absorbing coating covering at least in part the substrate between the colorant and the substrate, the radiation absorbing coating absorbing radiation at the predetermined wavelength so that the sensed reflected radiation is substantially a function of the thickness of the substrate and the colorant.

5. A colorant transfer media, comprising:
a substrate having first and second surfaces;
a colorant covering at least a part of the first surface, the colorant on the substrate creating a transfer surface for the colorant away from the substrate; and
a radiation absorbing layer formed between the colorant and the substrate.

6. A process of making a media, comprising the steps of:
forming a substrate having a first major surface;
forming a focus light absorbing layer on the first major surface; and
forming a colorant layer on the focus light absorbing layer.

7. A method for focusing a beam of radiation from a print head in a printing system, the beam of radiation falling within a range of values from a first wavelength to a second wavelength, that includes a donor and a receptor, the donor material transferring colorant to the receptor material when the donor material is impinged upon by the beam of radiation, comprising the steps of:
providing a donor having a radiation absorbing layer for absorbing radiation at a predetermined level at a third wavelength that is not between the first wavelength and second wavelength;
providing a second beam of radiation directed toward the donor, the second beam of radiation be at the third wavelength;
detecting a return signal of the second beam of radiation from the donor;
moving the print head as function of the return signal.

8. An image transfer system, comprising:
a substrate having a first major surface;
a light absorbing layer formed on the substrate;
a colorant layer formed on the first major surface; and
a recipient.

9. The image transfer system of claim 8, wherein the light absorbing layer is formed between the colorant layer and the first surface.

10. The image transfer system of claim 8, wherein the substrate also has a second major surface, the light absorbing layer being formed on the second major surface of the substrate.

11. A printing system comprising:
a donor having a substrate a colorant layer and a light absorbing layer, the colorant layer releasing from substrate when impinged by radiation of a wavelength between first and second pre-selected wavelengths, the light absorbing layer substantially absorbing light at a third wavelength;
a recipient for receiving the colorant when released from the donor;
a printer head having first and second radiation sources, the first radiation source producing first radiation directed toward the donor, the first radiation having a wavelength between the first and second wavelengths and the second radiation source producing second radiation at a third wavelength directed toward the donor;
a detector for detecting a return signal from the second radiation; and
a focus mechanism for focusing the first radiation source as a function of the return signal.

12. The printing system of claim 11, wherein the light absorbing layer is formed between the substrate and the colorant layer.

13. The printing system of claim 11, wherein the substrate has first and second major surface, the colorant layer being formed on the first major surface and the light absorbing layer being formed on the second major surface.

14. The printing system of claim 11, wherein the light absorbing layer is formed as a part of the colorant layer.

15. The printing system of claim 11, wherein the focusing mechanism further comprises:
a processor in operational connection with the detector;
a positionable lens, the lens being positionable to adjust the focus of the first radiation;
a drive connected to the processor for positioning the lens as a function of the return signal, the processor receiving a representation of the return signal from the detector and producing a drive signal to the drive so that the first radiation is focused on the colorant.

16. A process of making a media, comprising the steps of:
forming a substrate having a first major surface;
forming a colorant layer on the first major surface; and
including a light absorbing material in the colorant layer>
